(19) United States
(12) Patent Application Publication
(10) Pub. No.: US 2001/0040370 A1
(43) Pub. Date: Nov. 15, 2001

(54) E-mail telecommunications directory

(75) Inventor: Robert Pendergist, Brielle, NJ (US)

Correspondence Address: Michael I Kroll, 171 Stillwell Lane, Syosset, NY, 11791, US

(73) Assignee: Pendergist

(21) Appl. No.: 09/490,945

(22) Filed: Jan. 24, 2000

(51) Int. Cl. G09C 1/00

(52) U.S. Cl. 283/17

(57) ABSTRACT

A telecommunications directory for providing a user with a list of e-mail addresses associated with individuals. The telecommunications directory includes a front cover, a back cover and a binding connecting the front and back covers to form a book. A plurality pages are retained between the front and back cover by the binder and include indicia indicating a plurality of names, physical addresses and e-mail addresses associated with each name. The pages may be secured to the binder or releasably connected to the binder by a plurality of tabs. Each tab extends along a length of the binder and is positioned between the front and back covers. The plurality of pages are releasably secured to the tabs. The plurality of pages may also include indicia printed thereon providing space for entering additional information regarding an entity including telephone number, facsimile number, cellular telephone number and pager number of the entity. A plurality of blank pages may also releasably secured between front and back covers. A plurality of labels may be provided, each label including indicia printed thereon providing space for entering information regarding an entity. The plurality of pages each include an adhesive strip extending along a length thereof and a cover removably positioned to cover the adhesive strip when the cover of a selected one of the preprinted or blank pages is removed, the adhesive strip is selectably secured to a respective one of the tabs for securing the selected page to the tab.

### BACKGROUND OF THE INVENTION

1. Field of the Invention

The present invention relates generally to directories and, more specifically, to a telephone directory including imprinted pages providing e-mail addresses of persons located in any geographic region of the world and, additionally, the directory may provide space for insertion of information such as fax and phone numbers, the imprinted pages being arranged into topical sections and being removably inserted into the directory for placement in a desired section. Also included are labels including identifying indicia for placement over information within the directory which has changed.

2. Description of the Prior Art

Over the last twenty (20) years the telecommunications industry has experienced a state of unprecedented growth. This growth has included the continually growing popularity of devices such as pagers, cellular telephones and the Internet. As a result of the popularity of these devices, the telephone exchange numbering system has become notoriously unstable. Where it was once possible for a business or individual to keep the same area code and telephone number for many years if not throughout the life of the person or business, today it is highly unlikely to maintain the same telephone number if one should move locations or homes, even within the immediate area. With the advent of pagers, cellular telephones and the Internet, the telephone exchange system is continuously changing due to the assigning, reassigning and formation of new area codes to keep up with the substantial increase in the number of telephone lines in use.

Furthermore, the unparalleled growth of the Internet, with nearly 100 million users in the United States alone, has caused the formation of an ever expanding electronic nail (e-mail) industry. As recently as ten years ago, e-mail was considered a novelty. Such is no longer the case. E-mail has now become the preferred method of communication between friends, business associates and even distant family members. The main attractions of e-mail are its ease of use, ability to compose and receive messages at anytime as long as a computer and telephone line are available, the ability to transmit messages at any time without the need for the receiving party to be available and messages are almost instantaneously received by an account assigned to the receiving party who can access the message upon logging onto the account.

With this explosion of technology in the telecommunications area have come a wave of new addresses and numbers for contacting individuals as well as a high rate of change of such addresses and numbers. Conventional address directories are unable to accommodate the high rate of change of addresses and numbers as well as the increased amount of addresses and numbers per person or business.

Numerous types of telecommunication directories have been provided in the prior art. For example, U.S. Pat. No. Des. 379,181; U.S. Pat. Nos. 4,543,452; 4,661,976; 4,862,497 and 5,742,769 all are illustrative of such prior art.

### U.S. Pat. No. Des. 379,181

### Inventor: Tadahisa Sawano

### Issued: May 13, 1997

This patent discloses an ornamental design for a combined pager, telephone dialer and electronic calculator. The device is able to provide the functions of a telephone book, calendar, schedule book and memo book.

### U.S. Pat. No. 4,543,452

### Inventor: Heiko Ippen

### Issued: Sep. 24, 1985

The invention relates to an apparatus for the storage and recovery of information and subscriber's numbers while using a telephone register. By means of selection keys, the desired register card is removed from a stack of such cards by extending a drawer or the flapping up of a cover. A device connectable to a telephone makes it possible to automatically call up and dial stored subscriber's numbers. The keyboards with the selection keys of the telephone register and the subscriber's number dialing device are arranged in juxtaposed or superimposed manner in the telephone register casing.

### U.S. Pat. No. 4,661,976

### Inventor: Maxim F. Basch

### Issued: Apr. 28, 1987

An automatic telephone dialer device comprising, in combination an electronic telephone book with a plurality of pages, each with a capability for having listed thereon a plurality of entries in a column and line array. A random access memory means for storing at predetermined locations encoded data corresponding to each entry and microprocessor means for cooperative functional relationship with the memory means by receiving encoded data for locating in a predetermined location of the memory means, by providing an address accumulator for predetermining locations within the memory means and by retrieving by random access the encoded data from the predetermined locations. One or more signal generators for providing, in response to encoded data received from the microprocessor means, a chain of signals to telephone lines are provided along with a plurality of page sensors transmitting a signal representing the page being viewed and a plurality of column and line actuators, each operable to a condition representing the column and line selected. Upon operation for telephone dialing purposes and upon a complete location being received by the address accumulator, data is transmitted from memory means to the data buffer of the microprocessor means and a telephone number is automatically dialed by signals generated by the signal generator.

### U.S. Pat. No. 4,862,497

### Inventor: Raymond A. Seto

### Issued: Aug. 29, 1989

A hybrid alphanumeric directory comprises a portable notebook containing a plurality of loosely bound pages, each of which has several writing areas where alphanumeric information can be entered. The writing areas are on each page in the same relative position. When the notebook is placed on the receiving surface of an electronic unit, an arrangement is provided to determine which page is open and this automatically associates the push-buttons with the respective writing areas of the open page. Data associated with the writing areas are electronically stored. When a push-button besides a writing area of an open page is depressed, an operation associated with the stored data pertaining to that writing area is automatically initiated. The directory is particularly useful as a telephone directory, in which case the data are stored telephone numbers. Depression of one of the push-buttons causes the stored telephone number to be automatically dialed.

### U.S. Pat. No. 5,742,769

### Inventor: Eugene H. Lee

### Issued: Apr. 21, 1998

A directory service allows a user to receive email messages from senders without requiring the user to reveal his/her email address. The directory service maintains users' email addresses but allows users to restrict the display of their email addresses. The directory service can cause a message to be sent from a sender to a recipient without revealing the recipient's email address.

While these units may be suitable for the particular purpose to which they address, they would not be as suitable for the purposes of the present invention as heretofore described.

It is therefor desirable to provide a telecommunications directory able to provide email addresses for all persons located in any geographical region thereby allowing a person to be contacted in spite of physical address changes. It is further desirable to provide a telecommunications directory able to provide means for users to edit the e-mail entries within the directory. It is still further desirable to provide a telecommunications directory able to be organized and rearranged in any manner desired by the user by providing selectively movable pages. It is yet further desirable to provide a telecommunications directory including removable labels for facilitating editing of entries in the directory and providing additional space for the entry of more information concerning an entry in the directory.

### SUMMARY OF THE PRESENT INVENTION

The present invention relates generally to directories and, more specifically, to a telephone directory including imprinted pages providing e-mail addresses of persons located in any geographic region of the world and, additionally, the directory may provide space for insertion of information such as fax and phone numbers, the imprinted pages being arranged into topical sections and being removably inserted into the directory for placement in a desired section. Also included are labels including identifying indicia for placement over information within the directory which has changed.

A primary object of the present invention is to provide a telecommunications directory that will overcome the shortcomings of prior art devices.

Another object of the present invention is to provide a telecommunications directory which is able to provide e-mail addresses for individuals.

A further object of the present invention is to provide a telecommunications directory which is able to provide the e-mail addresses in an ordered manner based upon the name of the individual.

An even further object of the present invention is to provide a telecommunications directory including numerous items of information regarding each entry and providing means for the user to insert additional information and organize the directory as desired.

A still further object of the present invention is to provide a telecommunications directory including topical headings for insertion of information including name, address, e-mail address, URL, fax and telephone numbers.

A yet further object of the present invention is to provide a telecommunications directory wherein the pages of the directory are divided into sections and are selectively removable from the directory for reinsertion into a desired section.

A still further object of the present invention is to provide a telecommunications directory including a plurality of pages having removable labels to allow for insertion of additional information by a user, the labels are able to be applied within the directory at a position desired by the user.

Another object of the present invention is to provide a telecommunications directory that is simple and easy to use.

A still further object of the present invention is to provide a telecommunications directory that is economical in cost to manufacture.

Additional objects of the present invention will appear as the description proceeds.

A telecommunications directory for providing a user with a list of e-mail addresses associated with individuals is disclosed by the present invention. . The telecommunications directory includes a front cover, a back cover and a binding connecting the front and back covers to form a book. A plurality pages are retained between the front and back cover by the binder and include indicia indicating a plurality of names, physical addresses and e-mail addresses associated with each name. The pages may be secured to the binder or releasably connected to the binder by a plurality of tabs. Each tab extends along a length of the binder and is positioned between the front and back covers. The plurality of pages are releasably secured to the tabs. The plurality of pages may also include indicia printed thereon providing space for entering additional information regarding an entity including telephone number, facsimile number, cellular telephone number and pager number of the entity. A plurality of blank pages may also releasably secured between front and back covers. A plurality of labels may be provided, each label including indicia printed thereon providing space for entering information regarding an entity. The plurality of pages each include an adhesive strip extending along a length thereof and a cover removably positioned to cover the adhesive strip when the cover of a selected one of the preprinted or blank pages is removed, the adhesive strip is selectably secured to a respective one of the tabs for securing the selected page to the tab.

To the accomplishment of the above and related objects, this invention may be embodied in the form illustrated in the accompanying drawings, attention being ca led to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a top perspective view of the telecommunications directory of the present invention;

FIG. 2 is a front view of a page of the telecommunications directory of the present invention;

FIG. 2A is a front view of a page of the telecommunications directory of the present invention including advertisements mixed in with the individual entries;

FIG. 2B is a front view of a page of the telecommunications directory of the present invention including additional information and space for adding and editing information;

FIG. 3 is a front view of a page of removable labels for use with the telecommunications directory of the present invention;

FIG. 4 is a front view of a blank page of the telecommunications directory of the present invention with which a user may construct a custom personalized list for the directory, the page being selectively removable for placement at any position within the directory; and

FIG. 5 is a back side view of a page of the telecommunications directory of the present invention showing the removal of a cover for an adhesive strip on the page whereby the adhesive is used to secure the page at a desired location within the directory.

### DESCRIPTION OF THE REFERENCED NUMERALS

Turning now descriptively to the drawings, in which similar reference characters denote similar elements throughout the several views, the Figures illustrate the telecommunications directory of the present invention. With regard to the reference numerals used, the following numbering is used throughout the various drawing figures.

10 telecommunications directory of the present invention

12 front cover

14 back cover

16 binding

18 plurality of individual pages

20 first exemplary page of the telecommunications directory

21 second exemplary page of the telecommunications directory

22 space for entry of a name

23 advertisement on second exemplary page

24 space for entry of an address

25 e-mail address of company represented by advertisement

26 space for entry of an e-mail address

27 information identifying company and services in advertisement

28 space for entry of a telephone number

29 third exemplary page of the telecommunications directory

30 space for entry of a facsimile number

32 space for entry of a cellular telephone number

34 space for entry of a pager number

36 space for entry of a URL

38 additional pages

40 plurality of removable stickers

42 plurality of stickers for insertion of a name

44 indicia for insertion of a name

46 space for insertion of a name

48 stickers for insertion of an address

50 indicia for insertion of an address

52 space for accommodating the new address

54 stickers for insertion of a new e-mail address

56 indicia for insertion of a new e-mail address

58 space for accommodating the new e-mail address

60 stickers for insertion of a telephone number

62 indicia for insertion of a telephone number

64 space for accommodating the new telephone number

66 stickers for insertion of a facsimile number

68 indicia for insertion of a facsimile number

70 space for accommodating the new facsimile number

72 stickers for insertion of a cellular telephone number

74 indicia for insertion of a cellular telephone number

76 space for accommodating the new cellular telephone number

78 stickers for insertion of a pager number

80 indicia for insertion of a pager number

82 space for accommodating the new telephone number

84 stickers for insertion of a URL

86 indicia for insertion of a URL

88 space for accommodating the new URL

90 blank page

92 third entry

94 fourth entry

96 typical page of telecommunications directory

98 adhesive strip on typical page

100 cover for adhesive strip

### DETAILED DESCRIPTION OF THE PREFERRED EMBODIMENT

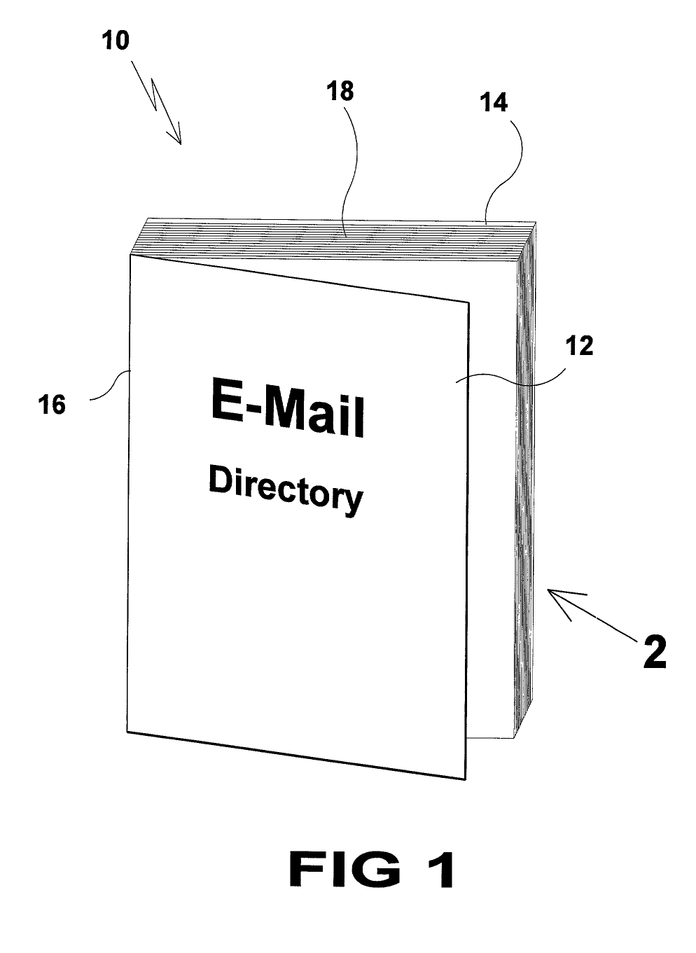

Turning now descriptively to the drawings, in which similar reference characters denote similar elements throughout the several views, FIGS. 1 through 5 illustrate the telecommunications directory of the present invention indicated generally by the numeral 10.

The telecommunications directory 10 is shown in perspective view in FIG. 1. The telecommunications directory 10 is a bound volume for organizing compilations of addresses and contact numbers primarily sorted in alphabetical order based upon the given proper name of the person identified by an e-mail address. The telecommunications directory 10 includes a front cover 12 and a back cover 14 held together by a binding 16. Between the front cover 12 and back cover 14 and held in place by the binding 16 are a plurality of individual pages 18 containing identification data regarding individuals, couples, groups or businesses. Entries identifying persons and entities are printed on the pages 18 and are preferably organized within the directory in alphabetical order. The directory 10 will preferably contain entries of persons and entities along with the e-mail addresses for each entry. The pages 18 may be selectively and releasably secured within the directory 10 thus allowing the user to organize the pages in any desired order based upon the individual desires of the user.

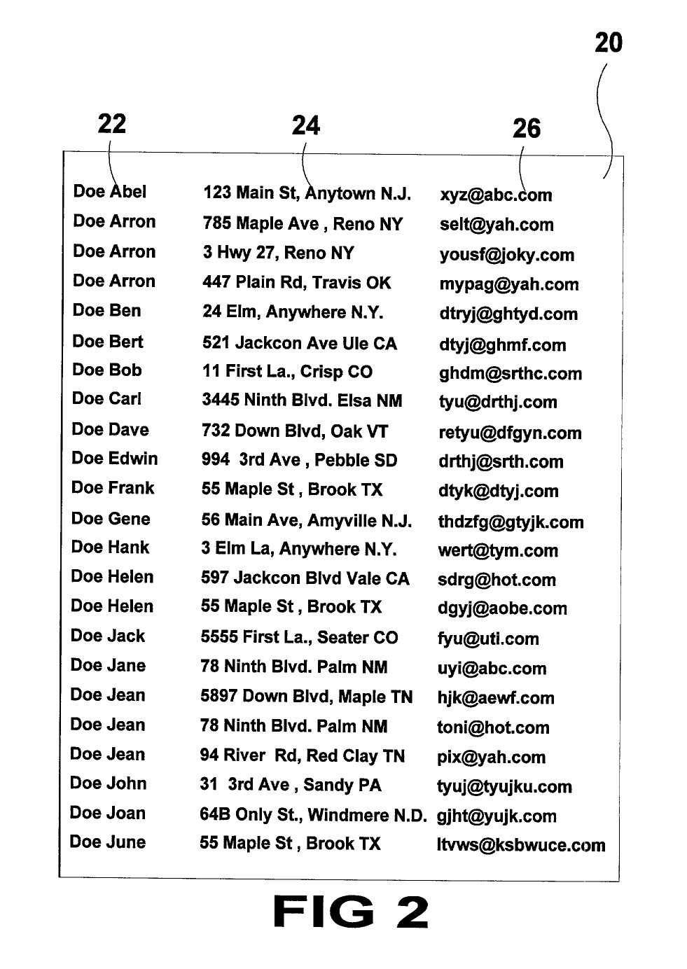

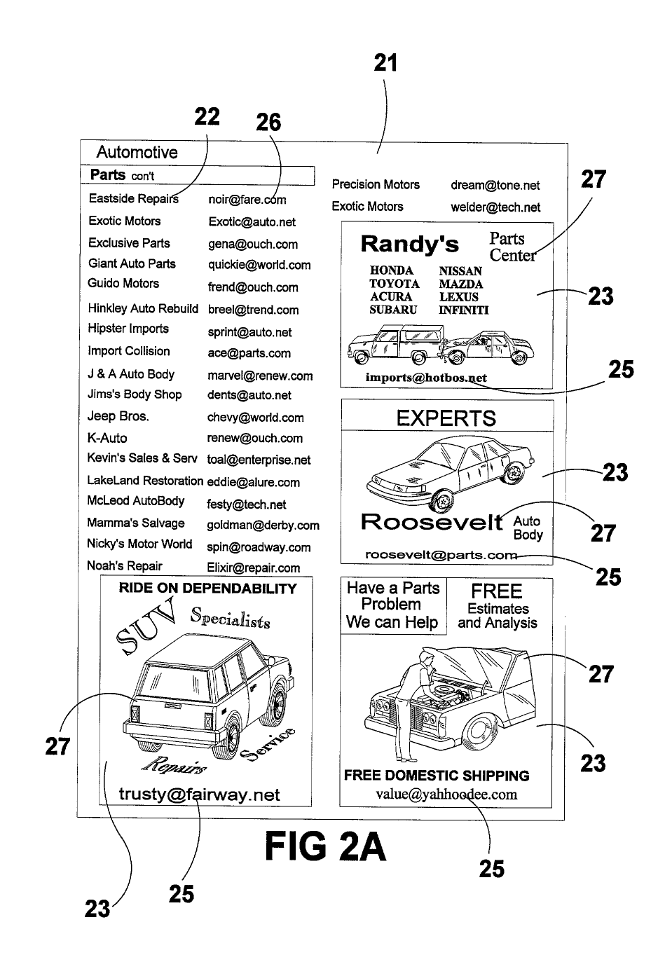

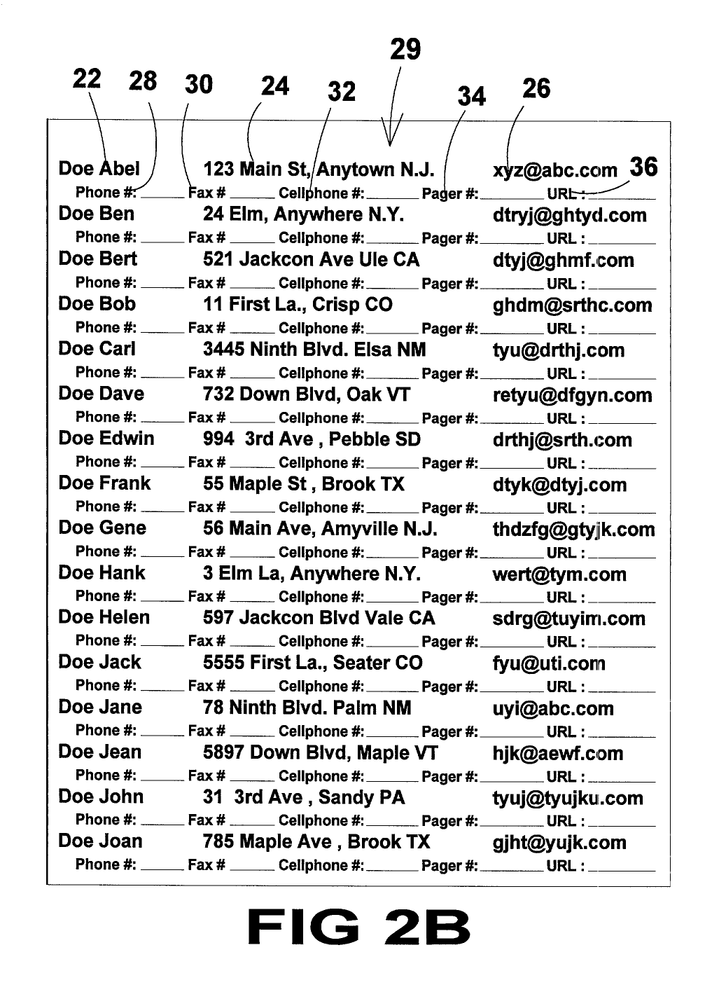

An exemplary page 20 of the directory is illustrated in FIG. 2. This figure shows the page 20 including a plurality of entries of people 22, a physical address 24 for each entry 22 and an email address 26 for each entry 22. The entries are organized in alphabetical order to provide a system for readily locating the e-mail address 26 for a particular entry 22. As can be seen from this figure, certain entries may be identified by a similar name. In such an instance the physical address 24 for the entry may be used to identify the correct entry of the person whose e-mail address is desired to be determined. For example, three (3) entries are present for Arron Doe. Two of the entries have a physical address in Reno New York and the third entry has a physical address in Travis Oklahoma. If it is desired to obtain the e-mail address for Arron Doe in Oklahoma, the email address is readily obtained by checking the entry for that particular Arron Doe. If it is desired to obtain the e-mail address of one of the other two Arron Doe's, the person searching for the e-mail address must know the street address for that individual. Thus, if the entry has a similar name to another entry, additional information may be needed to determine the e-mail address of the entry or a user may send a message to the e-mail address of each entry to determine which is the correct entry.

A second exemplary page 21 is illustrated in FIG. 2A. This page 21 includes a plurality of advertisements 23 mixed in with individual entries 22. Each of the advertisements 23 includes an e-mail address 25 for the company represented thereby and information 27 indicating the name and information regarding the company represented in the advertisement. These entries are provided for businesses and are also listed in alphabetical order within a subsection designed for the particular business area in which the entries practice. The directory would preferably have a subsection for all businesses in which at least one entry existed and the subsections would be listed alphabetically.

A third exemplary page 29 is illustrated in FIG. 2B. This figure shows the page 29 including a space for entry of a name 22 and entry of an address 24, names and addresses have already been inserted in their respective spaces 22 and 24. However, it is to be realized that prior to use, the pages may not include the names and addresses as shown. The names and addresses may be preprinted on the pages 29 prior to receipt by the user or alternatively, the pages may be blank with respect to the individual entries which will be inserted by a user when constructing lists within the telecommunications directory 10. In the event that the pages are blank with respect to the individual entries, the page will include headings providing space for insertion of certain information concerning the entry. In this instance the directory 10 will be user-customizable.

A space 26 is also provided for entry of an e-mail address along with a space 28 for entry of a telephone number. Similarly to the names and addresses discussed above, an e-mail address has been inserted in its respective space 26 in the figure for purposes of illustration. Prior to use, the pages do not include the e-mail addresses as shown. A space 30 is further provided for entry of a facsimile number along with a space 32 for entry of a cellular telephone number, a space 34 for entry of a pager number and a space 36 for entry of a URL. Each page 20 provides headings for entries of numerous persons, couples, groups and/or businesses.

While a preferred form for organizing the headings on a page 20 is shown and described herein, those of ordinary skill in the art who have read this description will appreciate that there are numerous other forms for organizing the headings on a page and, therefore, the present invention should be construed as including all such forms as long as they include the necessary headings and spaces for the insertion of information as required by this application, and therefore, that all such alternative forms are to be considered as equivalent to the one described herein.

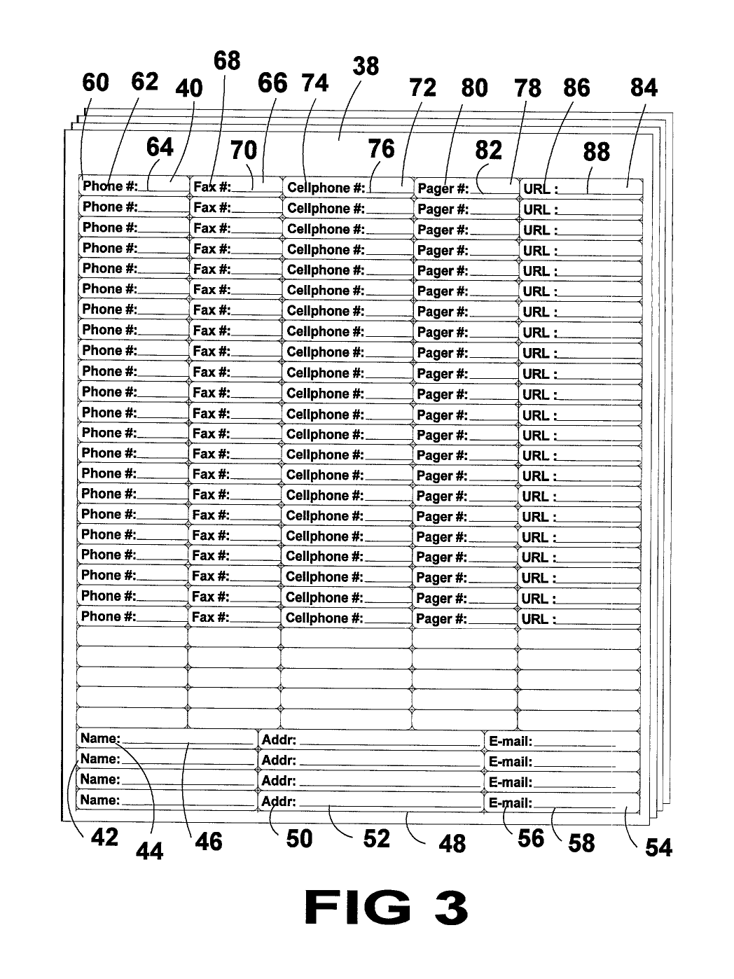

Additional pages 38 are provided for editing the printed pages 20 as illustrated in FIG. 3. As can be seen from this figure, the additional pages 38 include a plurality of removable stickers 40. Each sticker 40 is sized to cover a respective one of the entry spaces provided for insertion of information and shown in FIG. 2B. A plurality of stickers 42 include indicia 44 and a space 46 for insertion of a name. Such a sticker 42 may be used to cover up a previously entered name with a new name or to change a name previously entered. Other stickers 48 provide indicia 50 for insertion of an address, e.g. should the entity identified move or otherwise change addresses, and a space 52 for accommodating the new address. Additional stickers 54 are provided including indicia 56 for insertion of a new e-mail address and a space 58 for accommodating the new address. Stickers 60 are further provided with indicia 62 for insertion of a telephone number, e.g. should the entity identified move and receive a new telephone number or otherwise change their telephone number, and a space 64 for accommodating the new telephone number. Additional stickers 66 are further provided with indicia 68 for insertion of a facsimile number, e.g. should the entity identified move and receive a new facsimile number or otherwise change their facsimile number, and a space 70 for accommodating the new facsimile number. Further stickers 72 are provided with indicia 74 for insertion of a cellular telephone number, e.g. should the entity identified receive a new cellular telephone number or otherwise change their cellular telephone number, and a space 76 for accommodating the new cellular telephone number. Stickers 78 are also provided with indicia 80 for insertion of a pager number, e.g. should the entity identified receive a new pager number or otherwise change their pager number, and a space 82 for accommodating the new telephone number. Stickers 84 are also provided with indicia 86 for insertion of a URL, e.g. should the entity identified receive a new URL or otherwise change their URL, and a space 88 for accommodating the new URL.

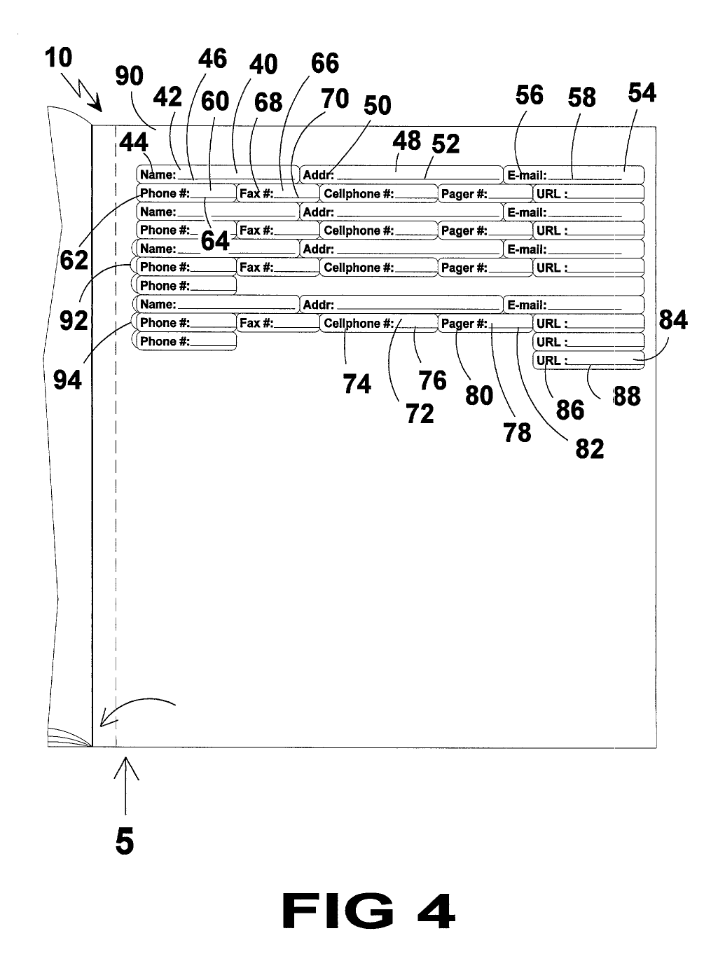

FIG. 4 illustrates a blank page 90 of the user-customizable telecommunications directory 10 including stickers 40 from the page 38 of FIG. 3 positioned thereon to create a personal directory designed exclusively by the user. This blank page 90 has been customized to provide enough space for each entity to be entered in a customized fashion. As can be seen, the user has provided enough space for the third entry 92 to include space for entry of two telephone numbers. For the fourth entry 94, space was provided to allow for the entry of two telephone numbers as well as for three URL entries. The blank page 90 and stickers 40 can be used to customize an entry in any manner desired to allow for multiple entries of any type for a single entity.

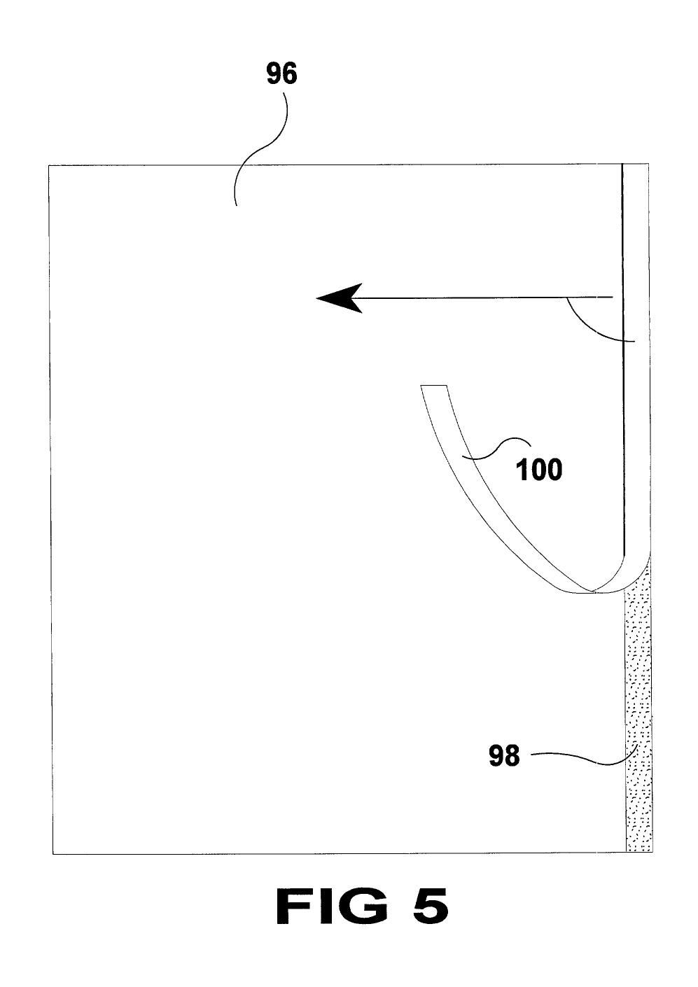

FIG. 5 illustrates a typical page 96 of the telecommunications directory 10. As can be seen from the figure, the typical page 96 includes an adhesive strip 98 positioned beneath a cover 100. When the cover 100 is removed from its position atop the adhesive strip 98 by pulling the cover 100 in the direction of the arrow, the adhesive strip 98 is exposed. The adhesive strip 98 is used to releasably secure the typical page 96 within the telecommunications directory 10. Securing of the typical page 96 is as illustrated in FIG. 4 wherein the adhesive strip 98 is positioned on an underside of the page 90 attached to a tab within the user-customizable telecommunications directory 10. The tab is indicated by the strip indicated by the dashed line in FIG. 4.

The operation of the telecommunications directory 10 will now be described with reference to the figures. In operation, the telecommunications directory 10 is provided to a user with a plurality of pages including indicia printed thereon including a plurality of names and e-mail addresses associated with each of the names. The names are preferably listed in alphbetical orde so the user can easily find the e-mail address of a desired person. Physical addresses may also be listed to help distinguish each entry The user will simply look up a name in the directory to find the e-mail address and then can correspond with a person through e-mail messages.

The directory may additionally include blank pages, a plurality of pages including indicia thereon for insertion of identifying information for an entry and a plurality of pages including preprinted labels including indicia thereon for insertion of select items of information thereon. The pages are in no specific order and may be arranged by the user.

Should the user prefer the arrangement provided by the preprinted pages, information concerning each entry, i.e. persons, couples, groups, businesses, etc. can be entered in the spaces provided. The information entered on the pages can include name, physical address, Internet e-mail address, URL, telephone number, pager number, cellular telephone number and facsimile number. The user may enter the information in any order desired. The preferred method of inserting information is in alphabetical order. Should the user insert information and then receive additional information whereby that information should be positioned at a place filled by previously entered information, the user may insert the information on labels including indicia provided for the information. The filled in labels may then be positioned on the page in the correct space so as not to upset the order of the telecommunications directory 10.

Alternatively, the user may create a page with the labels by positioning the labels on the page in any desired order as shown in FIG. 4. The creation of a page in this manner allows for the user to provide a required amount of space for each entry to include the necessary information. The user is thus able to design the telecommunications directory 10 in any manner desired to provide the easiest access to the needed information.

Once the pages are created and the information entered on the pages, the user can then organize the pages in any manner desired by removing the cover 100 from atop the adhesive on the page and exposing the adhesive strip 98. The adhesive strip 98 is then releasably secured to a desired tab in the user-customizable telecommunications directory 10 thereby placing the pages in a desired order.

From the above description it can be seen that the telecommunications directory of the present invention is able to overcome the shortcomings of prior art devices by providing a telecommunications directory which is able to provide e-mail addresses for individuals located in an ordered manner based upon the name of the individual. The telecommunications directory is also able to receive numerous items of information regarding each entry and providing means for the user to insert additional information and organize the directory as desired. The telecommunications directory includes topical headings for insertion of information including name, address, e-mail address, URL, fax and telephone numbers wherein the pages of the directory are divided into sections and are selectively removable from the directory for reinsertion into a desired section. The telecommunications directory also includes a plurality of pages having removable labels to allow for insertion of additional information by a user, the labels are able to be applied within the directory at a position desired by the user. Furthermore, the telecommunications directory of the present invention is simple and easy to use and economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A telecommunications directory for providing a user with a listing of e-mail addresses, said directory comprising:
a) a front cover;
b) a back cover;
c) a binding connecting said front cover to said back cover; and
d) a plurality of preprinted pages releasably secured between said front cover and said back cover by said binding, said plurality of pages including indicia printed thereon, said indicia representing individual entries, each entry including a name of an entity and an e-mail address associated with each name.

2. The telecommunications directory as recited in claim 1, wherein said indicia further includes a physical address associated with each name.

3. The telecommunications directory as recited in claim 1, wherein said names are listed in alphabetical order on said plurality of pages.

4. The telecommunications directory as recited in claim 1, further comprising a plurality of advertisements positioned on respective ones of said plurality of pages with said indicia.

5. The telecommunications directory as recited in claim 4, wherein said plurality of advertisements each include identifying indicia, said identifying indicia indicating a name of a company associated with the advertisement and an e-mail address for the company.

6. The telecommunications directory as recited in claim 1, wherein said indicia provides space for entering information regarding an entity including name, physical address, telephone number, facsimile number, cellular telephone number, pager number and e-mail address of the entity.

7. The telecommunications directory as recited in claim 1, further comprising a plurality of blank pages releasably secured between said front cover and said back cover by said binding.

8. The telecommunications directory as recited in claim 7, further comprising a plurality of labels, each of said labels including indicia printed thereon, said indicia providing space for entering information regarding an entity

9. The telecommunications directory as recited in claim 8, wherein said indicia provides space for entry of any one of name, physical address, telephone number, facsimile number, cellular telephone number, pager number and e-mail address of the entity.

10. The user-customizable telecommunications directory as recited in claim 9, wherein said labels are provided on a plurality of pages releasably secured between said front cover and said back cover by said binding.

11. The user-customizable telecommunications directory as recited in claim 1, wherein said binder includes a plurality of tabs extending therealong and positioned between said front cover and said back cover.

12. The user-customizable telecommunications directory as recited in claim 11, wherein said plurality of preprinted pages each further include an adhesive strip extending along a length thereof and a cover removably positioned to cover said adhesive strip, wherein when said cover of a selected one of said plurality of preprinted pages is removed, said adhesive strip is selectably secured to a respective one of said plurality of tabs for securing said selected preprinted page to said respective tab.

13. The user-customizable telecommunications directory as recited in claim 8, wherein said binder includes a plurality of tabs extending therealong and positioned between said front cover and said back cover.

14. The user-customizable telecommunications directory as recited in claim 13, wherein said plurality of blank pages each further include an adhesive strip extending along a length thereof and a cover removably positioned to cover said adhesive strip, wherein when said cover of a selected one of said plurality of blank pages is removed, said adhesive strip is selectably secured to a respective one of said plurality of tabs for securing said selected blank page to said respective tab.

15. The user-customizable telecommunications directory as recited in claim 9, wherein said labels are selectively applied in a desired fashion to respective ones of said plurality of blank pages to create a customized directory page.

16. The user-customizable telecommunications directory as recited in claim 9, wherein said labels are selectively secured over respective indicia on selected ones of said preprinted pages for editing information regarding an entity.

17. The user-customizable telecommunications directory as recited in claim 1, wherein said indicia further provides space for entry of a URL.

18. The user-customizable telecommunications directory as recited in claim 9, wherein said indicia on said plurality of labels further provides space for entry of a URL.
